(19) United States
(12) Patent Application Publication
(10) Pub. No.: US 2014/0226438 A1
(43) Pub. Date: Aug. 14, 2014

(54) ASSIGNED SCHEDULED ACQUISITION PROCESS IN WIRELESS EXPLORATION

(71) Applicant: WIRELESS SEISMIC, INC., Louisville, CO (US)

(72) Inventor: Marty Nurre, Richmond, TX (US)

(73) Assignee: WIRELESS SEISMIC, INC., Louisville, CO (US)

(21) Appl. No.: 13/766,391

(22) Filed: Feb. 13, 2013

(51) Int. Cl. G01V 1/04

(52) U.S. Cl. CPC G01V 1/04
USPC 367/14

(57) ABSTRACT

Seismic survey systems and methods that utilize a source event schedule to autonomously generate source events with reference to a reference clock. In this regard, a source event controller may be employed that is synchronized to a reference clock to generate source events with respect to the source event schedule and without requiring real time two way communication between an encoder and a decoder. Accordingly, source events may be generated at a known time even in terrains and environments where real time communication between an encoder and decoder are impractical or impossible.

### BACKGROUND

Seismic surveys are often used by natural resource exploration companies and other entities to create images of subsurface geologic structure. These images are used to determine the optimum places to drill for oil and gas and to plan and monitor enhanced resource recovery programs among other applications. Seismic surveys may also be used in a variety of contexts outside of natural resource exploration such as, for example, locating subterranean water and planning road construction.

A seismic survey is normally conducted by placing an array of vibration sensors (accelerometers or velocity sensors sometimes called “geophones”) on the ground, typically in a line or in a grid of rectangular or other geometry. Vibrations are created by a seismic source such as, for example, explosives or a mechanical device such as a vibrating energy source or a weight drop. The creation of vibrations by the seismic source may be referred to as a source event. Multiple source events may be used for some surveys. The vibrations from the source events propagate through the earth, taking various paths, refracting and reflecting from geological features such as discontinuities in the subsurface, and are detected by the array of vibration sensors. Signals from the sensors are amplified and digitized, either by separate electronics or internally in the case of “digital” sensors.

The digital data from the sensors of the array is eventually recorded on storage media, for example magnetic tape, or magnetic or optical disks, or other memory device, along with related information pertaining to the survey. The survey may include multiple source events and/or the active sensors that may move such that the process is continued until multiple seismic records is obtained for a number of source events to comprise a seismic survey. Data from the survey are processed on computers to create the desired information about subsurface geologic structure. In this regard, the seismic information from the sensors of the array is generally synchronized and combined to generate image information that can be interpreted to yield the desired survey result. Furthermore, the seismic information from the sensors may be analyzed relative to the source events to determine certain characteristics regarding the survey area. In general, as more sensors are used, placed closer together, and/or cover a wider area, the quality of the resulting image will improve. It has become common to use thousands of sensors in a seismic survey stretching over an area measured in square kilometers.

Several modes have been developed for reading out the data from the seismic units (e.g., conventional geophones or other units of a seismic survey). Conventionally, individual seismic units are connected by cables to form a line. However, in many cases, hundreds of kilometers of cables have been laid on the ground and used to connect the seismic units of such arrays. Large numbers of workers, motor vehicles, and helicopters are often used to deploy and retrieve these cables and the associated seismic sensors, which may be prone to damage or other issues associated with the cables. To avoid some of these difficulties, cableless readout modes have been developed. These include nodal and wireless readout systems.

In nodal systems, the data is generally stored at each unit until the conclusion of the survey. The data can then be read out on a unit-by-unit basis, for example, by retrieving the units or removable memory, or by porting each unit to a portable data collection unit either via a physical connector or via near field communications.

In wireless readout systems, data is generally read out from individual seismic units while the survey is ongoing, via wireless communications. This may occur in substantially real-time (e.g., as data is being acquired) or on another basis. While there is some latency associated with reading out data from these systems in real-time operation, e.g., associated with serial data transfer, these systems are often referred to as real-time systems to distinguish them from blind systems that generally do not involve reading out data with the survey is ongoing. Such wireless communications may be transmitted serially from unit-to-unit en route to a central collection point, or individual units may communicate directly with a base station.

Regardless of the nature of the read out modality of a seismic survey system, seismic information from the sensors of the array may be analyzed with respect to the timing one or more seismic source events. In this regard, it may be desirable to correlate acquired seismic data with source events to analyze the seismic data collected in response to the source event. In this regard, systems may be used to coordinate collection of seismic data relative to source events. However, the need for improved systems for such coordination between the collection of seismic data and source events continues.

### SUMMARY

In this regard, the present disclosure generally relates to conducting seismic surveys in a manner that facilitates correlation between the initiations of source events and corresponding seismic data acquired relating to the source event. In particular, the present disclosure generally relates to improved mechanisms by which to initiate seismic source at known times so as to provide accurate correlation between acquired seismic data and initiation of source events when processing acquired seismic data to provide information regarding subsurface features in the surveyed area. In particular, the present disclosure relates to an assigned scheduled acquisition process that enables source events to be generated without the requirement of two way radio frequency communications between an encoder and a decoder to signal the initiation of the source event. Accordingly, as will be described in greater detail below, the systems and methods described herein facilitate advantages over traditional systems by allowing for operation in more diverse environments, operation in environments where two way communication between encoder and decoder is difficult or not possible, and creation of exotic source event generation techniques not typically available in traditional systems.

A first aspect disclosed herein includes a method for generation of source events in seismic data acquisition. The method includes scheduling a plurality of source events to define a source event schedule that includes a plurality of source event scheduled times. The source event scheduled times are defined with respect to a reference clock. The method also includes providing the source event schedule to at least one seismic source (e.g., a mechanism of creation of seismic energy in the survey area such as an explosive charge, a weight drop, a vibration truck, or other source event generator). The seismic source is synchronized corresponding to the reference clock. The method further includes initiating a source event for at least one source event scheduled time as determined with reference to the reference clock at the seismic source.

Accordingly, the first aspect facilitates initiation of source events relative to a reference clock rather than relying on radio communications between an encoder and a decoder for each source event to be generated. As such, the source event schedule may be provided to the source event controller by any possible means such that after the source event controller obtains the source event schedule, the source event controller may operate at least partially autonomously to generate source events without requiring further control communications therewith. In this regard, the method of the first aspect may improve seismic survey operations by allowing for this autonomous operation of the source event controller.

A number of feature refinements and additional features are applicable to the first aspect. These feature refinements and additional features may be used individually or in any combination. As such, each of the following features that will be discussed may be, but are not required to be, used with any other feature or combination of features of the first aspect.

For example, in an embodiment the initiating of the source event may occur independently of control communications between a source event encoder and a source event decoder, e.g., the source event controller may operate autonomously. In an embodiment, the reference clock may comprise a GPS time reference signal.

In an embodiment, the source event schedule including the source event scheduled times may be stored in a central database. By storing the source event schedule and the central database, the schedule may be later accessed (e.g., during data processing) to determine the start times of the source events as determined by the source and schedule.

In an embodiment, the method may further include acquiring seismic data corresponding to the source event with at least one seismic data acquisition module with reference to the reference clock. As such, the method may include appending timestamp data regarding the reference clock to the seismic data. It will be appreciated that generation of source events relative to the reference clock and acquisition of seismic data timestamp relative to the reference clock may allow for correlation of the source event initiation time in the acquired data during data processing. Accordingly, in an embodiment the seismic data may be correlated to the source event schedule during post survey processing of the seismic data. As synchronization to the reference clock may be important to the operation of the survey, the method may also include synchronizing the seismic data acquisition module with regard to the reference clock. The synchronization may include reference to a GPS clock signal received at the acquisition module or other synchronization techniques known in the art. For instance, the synchronization may include a reference to a GPS clock signal received directly at the acquisition module or may be relayed via other modules within the array.

In an embodiment, the method may include distributing the source event schedule to the seismic data acquisition module. As such, the seismic data acquisition module may be able to operate with reference to the source event schedule. That is, the seismic data acquisition module may utilize the source event schedule during its operation. For example, in an embodiment the seismic data acquisition module may only acquire seismic data in a time corresponding to a source event scheduled time. In a further embodiment, the source event schedule may designate at least two of the plurality of source event scheduled times as corresponding to an acquisition stacking event to perform data stacking. As such, in an embodiment, the source event schedule may include instructions regarding the acquisition stacking event for controlling the operation of the seismic data acquisition module. In this case, the method may include combining, at the seismic data acquisition module, seismic data from each source event scheduled times. That is, operation of the seismic data acquisition module with respect to the source event schedule may allow for data stacking operations at the seismic data acquisition module. This operation may occur regardless of the nature of the seismic acquisition module such that, for example, the source event schedule may allow for data stacking operation to occur at cabled modules, wireless readout modules, blind readout modules, or any other acquisition module known in the art.

In various embodiments, the definitions of initiation of source events in the source event schedule a provided differently. For example, in an embodiment at least one of the plurality of source event scheduled times may correspond to an absolute time of the reference clock. For example, the absolute time may be a specific time of the day defined relative to an hour, minute, and second. In another embodiment, at least one of the plurality of source event scheduled times may correspond to a relative time. For example, the relative time may be defined as an offset relative to an absolute time or other event such as, for example, a predetermined time after a previously occurring source event or a predetermined time after absolute time defined in the source event schedule. Additionally, the relative time may be defined with regard to another event outside of the control of the source event controller such as, for example, a detectable event occurring in the seismic array or another event detectable, directly or indirectly, at the source event controller.

As described above, providing the source event scheduled to the source event controller and/or seismic data acquisition module may be accomplished by any convenient mechanism known in the art. For example, in an embodiment the providing may include sending the source event schedule from a remote location to the source event controller. In this regard, the sending may include wirelessly transmitting the source event schedule to the source event controller.

In an embodiment, the source event schedule may correspond to a predetermined time period. The predetermined period of time may relate to a predetermined period of the survey such as, an hour of operation, as full day of operation, as week of operation, or some other predetermined period of operation of the survey. In this regard, the length of the predetermined period of time to which the source event schedule corresponds may dictate the time between which the source event controller may not require external control signals to operate. That is, for example, if the source of an schedule corresponds to a week of time, the source of an controller may be operable to autonomously operate during the week without further control signals in provided thereto.

A second aspect the present invention includes a system for seismic data acquisition that includes a source event scheduler for generating of a source event schedule including at least one source event scheduled time. The source event scheduler may be provided at the source event controller or remotely from the source event controller without limitation. In any regard, at least one source event scheduled time is defined relative to a reference clock. The system also includes a source event controller in operative communication with the source event scheduler to receive the source event schedule. The source event controller is operable to generate a source event at the at least one source event scheduled time. In this regard, the source event generated by the source event controller is generated based on a clock at the source event controller synchronized to the reference clock and is independent of source encoder and source decoder communications.

A number of feature refinements and additional features are applicable to the second aspect. These feature refinements and additional features may be used individually or in any combination. As such, each of the following features that will be discussed may be, but are not required to be, used with any other feature or combination of features of the second aspect.

For example, in an embodiment the source event controller may further comprise an encoder operable to receive a control signal from a decoder to initiate a source event. The source event controller may be selectively operable to generate a source event based on the control signal received from the decoder or based on the source event schedule with reference to the reference clock. That is, the source event controller may be selectively configured to operate in either an assigned schedule acquisition mode or a remotely controlled mode that requires to a radius medication between and encoder and a decoder of the source event controller.

### BRIEF DESCRIPTION OF THE DRAWINGS

FIG. 1 depicts an embodiment of an acquisition system.

FIG. 2 depicts a schematic view of an embodiment of a data acquisition module.

FIG. 3 depicts a schematic view of an embodiment of a survey system described herein.

FIG. 4 depicts a schematic view of an embodiment of a source event schedule capable of being used by a source event controller to control source events in a survey.

FIG. 5 depicts an embodiment of a process according to the description herein.

FIG. 6A depicts an embodiment of serial collection of seismic data corresponding to different source events.

FIG. 6B depicts an embodiment of stacking seismic data corresponding to different spruce events.

### DETAILED DESCRIPTION

The following description is not intended to limit the invention to the forms disclosed herein. Consequently, variations and modifications commensurate with the following teachings, skill and knowledge of the relevant art, are within the scope of the present invention. The embodiments described herein are further intended to explain modes known of practicing the invention and to enable others skilled in the art to utilize the invention in such, or other embodiments and with various modifications required by the particular applications(s) or use(s) of the present invention.

As indicated above, when conducting a seismic survey, one or more source events may be created to generate seismic energy that may be detected by acquisition modules deployed in the survey area. In this regard, the acquired data may be processed to determine or analyze one or more subsurface features within the survey area. It may be appreciated that knowledge regarding the time at which data is collected in relation to when a source event occurred may be utilized in the analysis of the seismic data. Accordingly, a source event controller may be employed to control the creation of a source event (e.g., at a known time often referred to as a “time break”). Any number of seismic sources may be used such as, for example, explosive charges, air guns, vibrating equipment (commonly referred to as Vibroseis equipment), weight drops, etc. However, the location of source events may be geographically distributed. As such, control of source events may be facilitated by way of communication between an encoder provided remotely and a decoder at a source event controller. In this regard, communication between the encoder and decoder may be by way of RF communication techniques such as two-way radios or the like to control the initiation of energy sources in a survey.

As such, real time two way communication to control source events may be implemented an a number of ways. For example, the communication between the encoder and decoder may facilitate synchronized or asynchronous starts. The synchronous approach uses a source instrument controlled start that is provided at the delivery of a time break. The time break is a predicted event issued by source controllers coinciding with source energy events. Asynchronous starts begin at the delivery of a time break produced at the instance of a source event. In either case, the processing of acquired seismic data relies on the time break in the processing of the data.

However, the reliance on real-time two-way communication between the encoder in the decoder of the source event controller may be present difficulties or inaccuracies in the seismic survey. For example, seismic surveys are often conducted in remote or inhospitable environments. For example, characteristics of these environments (e.g., separation by long distances, dense vegetation, radio frequency interference, etc.) may impede the ability to effectively useradio communications between an encoder and decoder at the source event controller to control the generation of source events. For example, oftentimes the encoder and decoder are separated by large distances or by relatively radio-opaque environments (e.g., jungles, swamps, or the like). In this regard, requiring a real time two way radio communication between the encoder and decoder of the source event controller not be possible and, control of the seismic source events may be interfered with or completely prevented.

Furthermore, especially in the case of radio communications over great distances, propagation delays, processing delays, or other latency associated with the communication may result in errors associated with the timing of the initiation of the source events. For example., errors regarding the timing of the time break may result in initiation of seismic events at a time different than intended due to system latency associated with the delay of two way radio communications. As such, there may be errors introduced in the acquired seismic data based on offsets between the ideal initiation of seismic events and the actual initiation of seismic events. That is, system latency associated with real time two way RF communications between encoder and decoder of the source event controller 320 may contribute to processing errors in the seismic data once acquired. Furthermore, reliance on to a communication between the encoder and decoder of the source event controller may inhibit the ability to perform seismic surveys in a variety of conditions that are unfavorable to such two-way radio communication.

In this regard and as indicated above, the present disclosure generally relates to conducting seismic surveys with seismic source event generation that is at least partially based on a source event schedule. Specifically, the present disclosure relates to the control and timing of the generation of one or more seismic source events by a source event controller based on a source event schedule and with reference to a reference clock to generate seismic energy to be collected by an acquisition system. The coordination of seismic data acquisition with one or more seismic source events may allow for a seismic survey to generate data regarding subsurface features of interest in the survey area (e.g., by calculating propagation delays from a known source event start time to data features appearing in the acquired seismic data or by other data processing methods facilitated by known source event initiation times). Furthermore, the coordination of seismic data acquisition with known source event timing may facilitate advanced data acquisition techniques (e.g., data stacking, source event sweeps, etc.).

In this regard, the description that follows generally includes a discussion regarding examples of seismic data acquisition systems that may be employed to acquire seismic data. While one such example of a system is discussed, namely a cableless data acquisition system, it will be appreciated the teachings contained herein may be utilized in conjunction with any type of seismic data acquisition system without limitation. Thereafter, the present disclosure turns to a discussion of systems and methods for the coordination of seismic data acquisition and one or more seismic source events including various embodiments of acquisition techniques facilitated by the coordination of seismic data acquisition and seismic source events as described herein.

The present disclosure may be generally applicable to any system used in seismic data acquisition that employs data acquisition modules to acquire seismic data in response to a seismic source event. As indicated above, various approaches to seismic data acquisition and data read out have been proposed. Examples include, for example, cabled systems, autonomous systems, cableless systems, etc. In this regard, regardless of the type of survey system employed, the correlation of source events with acquired seismic data may be facilitated by the systems described herein. Accordingly, any type of survey system now known or developed hereafter including different combinations of survey system types may utilize the teachings herein to correlate acquired seismic data with seismic source events without limitation. However for purposes of explanation, an embodiment of a wireless readout seismic survey system is described herein. For example, the embodiment described herein may include any or all features of the wireless readout seismic survey system described in U.S. Pat. No. 7,773,457, which is incorporated by reference herein in its entirety. However it is to be understood that the wireless survey system described herein is presented as a non-limiting example and the embodiments described herein are not intended to limit the disclosure to wireless readout seismic survey systems.

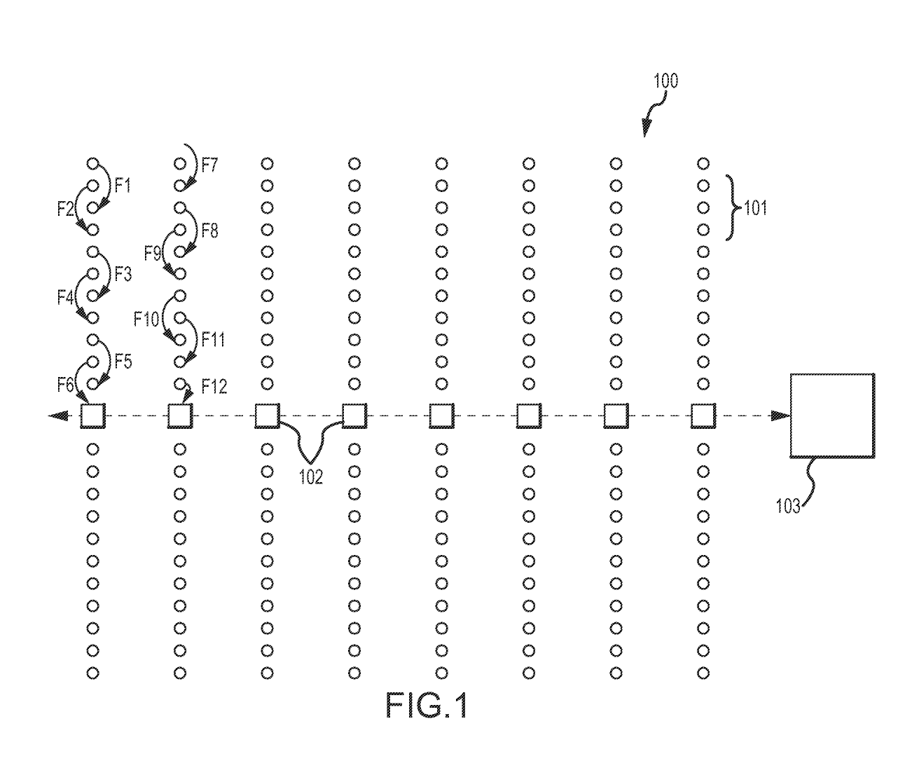

An embodiment of a wireless readout seismic survey system 100 is depicted in FIG. 1. The seismic acquisition system 100 may include all or any of the features described in U.S. Pat. No. 7,773,457. For example, a number of remote seismic data acquisition modules 101 may be arranged in lines within the survey area as may be typically done with traditional wired systems. However, in the system 100 of FIG. 1, there may be no physical connection between the modules 101 that facilitate data transfer. Rather, data transfer may be facilitated by wireless communication between the modules 101. In this regard, the modules 101 may be operable to transmit acquired seismic data to base station modules 102 that may be provided in the survey area. The base station modules 102 may be connected to a central control and recording system 103 by Ethernet, fiber optic, or other digital data link or a wireless substitute. Example radio links operating on frequencies F1 to F12 are indicated by arrows in FIG. 1 indicating the wireless transmission of data in the system 100. Other radio transmission paths are possible, including direct transmission to the nearest module, transmitting to multiple modules up or downstream of a given module, pasta given module (e.g., in the case of an obstruction or equipment fault), or even across to another line or any other logical path that establishes a communication flow.

The central control and recording system 103 may be a notebook computer or larger equivalent system and may be used to store and potentially process the acquired seismic data. In any regard, acquired seismic data may be communicated from each of the seismic data acquisition modules 101 to a base station 102 and on to a central control and recording station 103. The central control and recording station 103 may be operable to store the seismic data for later processing. In this regard, data processing techniques may be employed to determine data regarding the seismic survey area in any appropriate manner as known to the art.

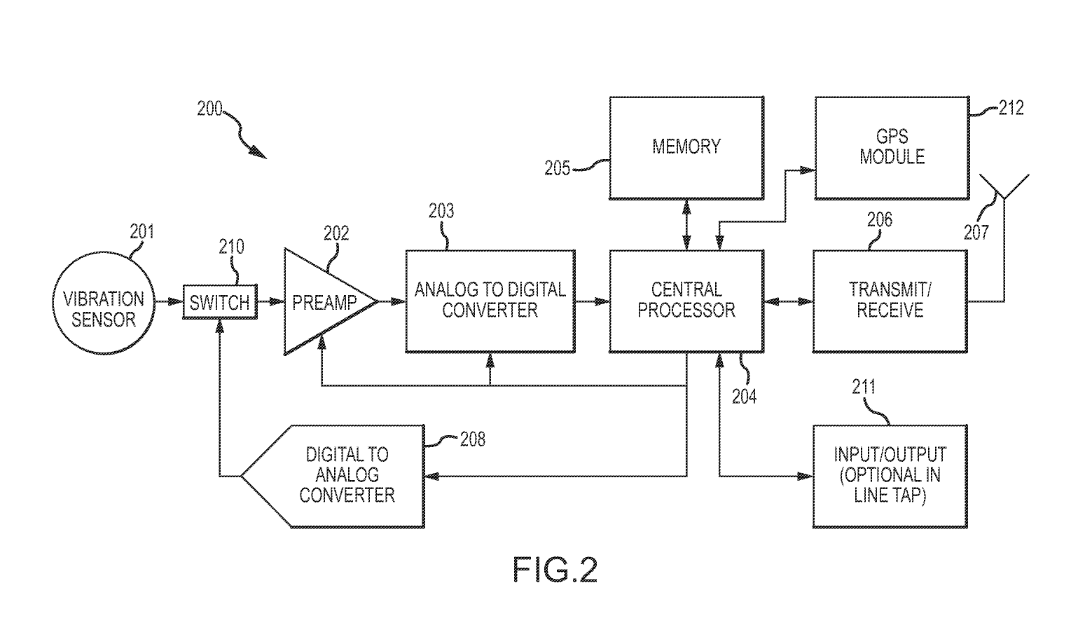

An embodiment of a seismic acquisition module 200 of the seismic acquisition system 100 is depicted in FIG. 2. The seismic acquisition module 200 may include a vibration sensor 201 that may convert vibrations into electrical signals which are fed through switch 210 to preamplifier 202 and thence to the analog to digital (A/D) converter 203. The digital data from the A/D converter 203 may be fed into a processor 204 or directly into a digital memory 205. Alternately, in the case of a sensor 201 with direct digital output, the signals may flow directly to the processor 204 or memory 205.

In addition to controlling the module 200 and storing the data in the memory 205, the processor 204 may perform some calculations on the data including decimation, filtering, stacking repetitive records (described in greater detail below), correlation, timing, etc. The remote module 200 may also receive information through the transceiver 206, for example: timing information, cross-correlation reference signals, acquisition parameters, test and programming instructions, location information, seismic data from upstream modules and updates to the software, among other commands. The transmit and receive signals couple through antenna 207. The processor 204 may control the transceiver 206, including transmit/receive status, frequencies, power output, and data flow as well as other functions required for operation. The remote module 200 can also receive data and commands from another remote module or base station, store them in the memory, and then transmit them again for reception by another remote module up or down the line.

In one embodiment, the module 200 may be operable to both store seismic data received from the vibration sensor 201 as well as transmit the seismic data to another module or central recording unit. In this regard, the memory 205 may be a data buffer that continually records new data into the buffer while deleting the oldest data from the buffer to free memory space for newly received data. The memory 205 may be sufficient to hold a relatively large amount of data (e.g., approaching or equaling the amount of memory space that would be required to capture the entire survey in memory). For example, the memory 205 may be operable to hold in as data buffer at least about 60 minutes of a seismic data record, or more.

A digital-to-analog (D/A) converter 208 may be included in the system which can accept digital data from the processor 204 to apply signals through a switch 210 to the input circuitry. These signals, which may for example consist of DC voltages, currents, or sine waves, can be digitized and analyzed to determine if the system is functioning properly and meeting its performance specifications. Typical analysis might include input noise, harmonic distortion, dynamic range, DC offset, and other tests or measurements. Signals may also be fed to the sensor 201 to determine such parameters as resistance, leakage, sensitivity, damping and natural frequency. The power supply voltage may also he connected through the switch 210 to the A/D converter 203 to monitor battery charge and/or system power. The preamplifier 202 may have adjustable gain set by the processor 204 or other means to adjust for input signal levels. The vibration sensor 201 may be a separate generic unit external to the remote module 200 and connected by cables, or the sensor 201 might be integral to the remote module package.

If the remote module 200 is to be used as a base station, equivalent to a “line-tap” or interface to the central recording system, it may also have a digital input/output function 211 which may be, for example, an Ethernet, USB, fiber-optic link, or some computer compatible wireless interface (e.g., one of the IEEE 802.11 standards) or another means of communication through a wired or radio link. It may be acceptable to use larger battery packs for the line tap wireless data acquisition and relay modules because they will normally be relatively few in number and may communicate over greater distances using a high speed data communication protocol.

The remote module 200 may be constructed of common integrated circuits available from a number of vendors. The transmit/receive integrated circuit 206 could be a digital data transceiver with programmable functions including power output, timing, frequency of operation, bandwidth, and other necessary functions. The operating frequency band may preferably be a frequency range which allows for unlicensed operation worldwide, for example, the 2.4 GHz range. The processor 204, memory 205, and switch 210 can include any of a number of generic parts widely available. The A/D converter 203 could preferably be a 24-bit sigma delta converter such as those available from a number of vendors. The preamplifier 202 should preferably be a low-noise, differential input amplifier available from a number of sources, or alternatively integrated with the A/D converter 203. The D/A converter 208 should preferably be a very low distortion unit which is capable of producing low-distortion sine waves which can be used by the system to conduct harmonic distortion tests.

The module 200 may also include a global positioning system (GPS) module 212. The GPS receiver 212 may be operable to receive location and/or timing data from GPS satellites in a manner known in the art. In this regard, the location of the module 200 may be resolved by the GPS receiver 212 and location data may be provided to the processor 204. In turn, the location data may be communicated on by the module 200 or may, for example, be appended to acquired seismic data. Furthermore, the GPS receiver 212 may receive timing information regarding a GPS timing reference. The GPS timing reference may be used to train a clock maintained by the processor 204 for the module 200. In this regard, the module clock may be synchronized to the GPS timing reference. In turn, the seismic data may be appended with timing information from the module clock such that the time at which data was acquired may be provided with the data. Additionally, the module 200 may include a number of other components not shown in FIG. 2, such as a directional antennae for AOA signal measurements, separate transmit and receive antennae, separate antennae for location signals and seismic data transfer signals, GPS receivers, batteries, etc.

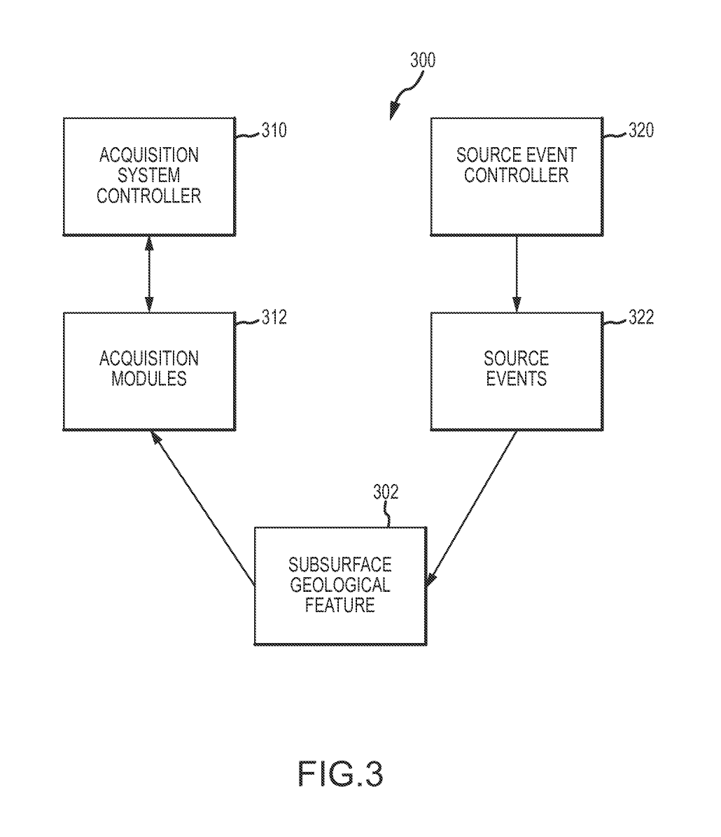

FIG. 3 generally depicts various components of a seismic acquisition system and a seismic source event system as may be used to conduct a seismic survey. The resulting seismic survey system 300 may include an acquisition system controller 310 and a source event controller 320. The acquisition system controller 310 may be in communication with and operable to control the execution of one or more seismic acquisition modules 312. For example, the seismic acquisition modules 312 may be of the kind discussed above with respect to FIG. 2, or other seismic acquisition modules known in the art that are capable of acquiring seismic data, may be used without limitation. In this regard, the acquisition system controller 310 may be located at a central control and recording station, a base station unit, a single acquisition device, or may be collectively distributed among one or more module in the survey system.

The source event controller 320 may be operable to create, initiate, or otherwise generate one or more seismic source events 322. The source event 322 may comprise any known seismic source event employed in the art including, but not limited to, detonation of explosives, activation of vibration equipment, control of a weight drop, or other known means of creating seismic energy capable of being detected by a seismic survey system. In any regard, upon generation of the source event 322, seismic energy may propagate through subsurface features including, for example, subsurface geological features 302. The seismic energy that encounters the subsurface geological features 302 may be reflected and/or refracted through the subsurface and received at the acquisition modules 312. In this regard, the acquisition modules 312 may measure the seismic energy from the subsurface geological features 302. From the seismic data collected by the seismic acquisition modules 312, information regarding the subsurface geological features 302 may be ascertained through analysis of the seismic data acquired by the acquisition modules 312.

The acquisition system controller 310 and source event controller 320 may be coordinated to enable correlation of seismic data acquired by the acquisition modules 312 with energy sources 322 initiated by the source event controller 320. In this regard, seismic data collected by the acquisition modules 312 may be correlated to specific ones of the energy sources 322 such that during the analysis of the seismic data acquired by the acquisition modules 312, relationships between the acquired seismic data acquisition modules 312 any energy source 322 may be analyzed to provide information regarding the subsurface geological features 302 as a function of the analysis of the seismic data relative to known parameters regarding the energy sources 322

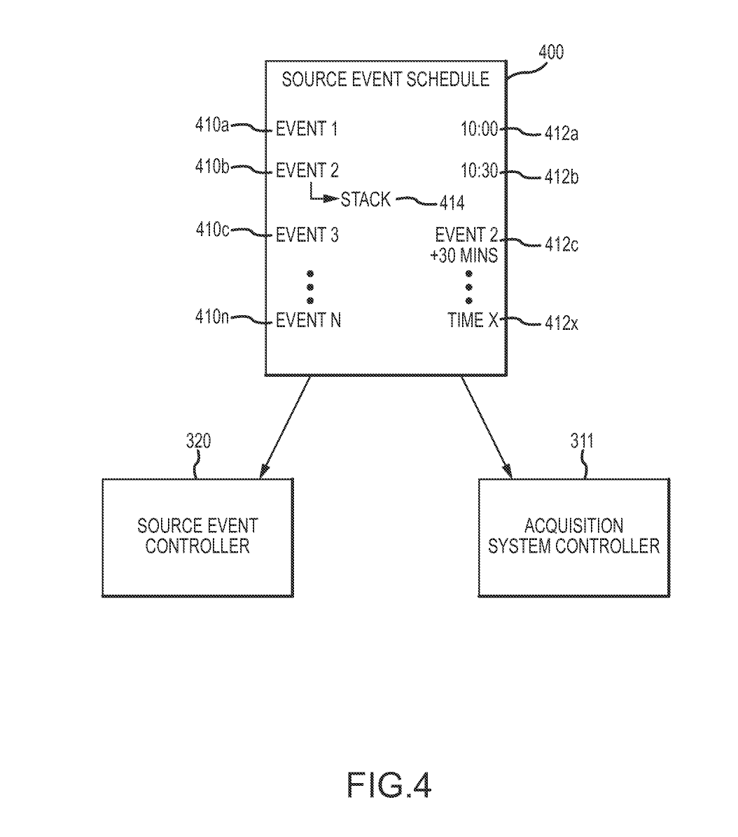

Accordingly, with further reference to FIG. 4, a source event schedule 400 may be generated that may be provided to the source event controller 320 such that the source event controller 320 may control the source events 322 with reference to the source event schedule 400. That is, once the source event controller 320 has received the source event schedule 400, the source event controller 320 may operate autonomously to control source events 322. In this regard, the generation of source events 322 may be based on the source event schedule 400 received at the source event controller 320 such that the source events 322 are created with reference to the source event schedule 400 rather than, for example, relying on real time two way communications between an encoder and decoder. As will be discussed further below, this technique may provide significant advantages in the control of source events during a seismic survey.

As may be appreciated in FIG. 4, the source event schedule 400 may include a plurality of source events 410a-410n. Each of the source events 410a-410n contained in the source event schedule 400 may have a respective source event scheduled time 412a-412x. The source event scheduled times 412a-412x may be defined relative to a reference clock. In this regard, each source event schedule time 412a-412x may be provided in relation to a reference clock. The source event controller 320 may include a local clock that may be synchronized with respect to the reference clock. As such, once the source event controller 320 receives the source event schedule 400, the source event controller 320 may be operable to generate source events 410a-410n at each given source event scheduled time 412a-412x based on the local clock synchronized to the reference clock. In this regard, the source event controller 320 generates source events 410a-410n relative to the reference clock as indicated by the source event schedule 400. As the source event controller 320 may be operable to generate source events without receiving any control commands from a remote location, the source event controller 320 may be characterized as autonomously generating source events 410a-410n.

Furthermore, a corresponding acquisition system controller 310 may also be synchronized to the reference clock such that one or more modules within a survey system may be synchronized relative to the reference clock. For example, in an embodiment, one or more (e.g., all) of the modules 312 may include a local clock that is adapted to be synchronized and operate according to the same reference clock referenced by the source event schedule 400. Accordingly, as depicted in FIG. 4, the source event schedule 400 may be distributed to the seismic source of a controller 320 and/or the acquisition system controller 310.

The distribution of the source event schedule 400 to the source event controller 320 and/or the acquisition system controller 310 may be accomplished in one or more of a number of modalities. For example, the source event schedule may comprise a data file that is readable by a processor at the source event controller 320, the acquisition system controller 310, and/or a seismic data acquisition module 200. In this regard, the source event schedule 400 may exist as one or more portions of program code on a non-transitory computer readable medium such as a physical memory device (e.g., a flash drive, USB drive, hard drive, or other physical memory known in the art). The source event schedule 400 may exist as any file format known in the art such as, for example, an extensible markup language (XML) file, spreadsheet file, text file, etc. As such, the source event schedule 400 may be provided physically to a device, e.g., by may of a physical memory device being engaged with the device. Additionally or alternatively, a device may be programmed with the source event schedule 400 prior to deployment to the seismic survey field. Further still, a device may be in operative communication with a memory storing the source event schedule thereon. In this regard, the source event schedule may be distributed directly to a device (e.g., by way of a wired medication link or wireless communication link). In yet another embodiment, the source event controller 320 may be utilized directly to generate the source event schedule 400 (e.g., by way of a user input at the source event controller 320). In any regard, the source event controller 320 and/or the acquisition system controller 310 may receive the source event schedule 400. In an embodiment, the source event schedule 400 may be encrypted, encoded, or otherwise secured or protected to prevent loss or tampering of the source event schedule 400.

As indicated above, the source event schedule 400 preferably includes a plurality of source events 410a-410n defined with corresponding source event scheduled times 412a-412x. In an embodiment, the source events 410a-410n may include all such source events to occur during a predetermined period of time of operation of the seismic survey. For example, the source events 410a-410n may be provided in the source event schedule 400 corresponding to a full day of survey operation. The source event schedule may correspond to other predetermined amounts of time without limitation (e.g., a period of hours, period of days, etc.). In this regard, during the predetermined period of time corresponding to the source event schedule 400, further communication between the source event controller 320 and a remote controller may be unnecessary such that the source event controller 320 may operate autonomously during the predetermined period. That is, the source event controller 320 may control seismic energy sources 322 with respect to the source event schedule 400 received at the source event controller 320 such that radio communication with the source event controller 320 may be discontinued and generation of seismic energy sources 322 may continue according to the source event schedule 400. In this regard, the potential issues corresponding to relying on two-way communications as a control mechanism for a source event controller may be reduced.

In an embodiment, the reference clock may be a GPS time reference signal. In this regard, a GPS receiver (e.g., GPS receiver 212 described above) may be operable to receive GPS timing signals from one or more GPS satellites. This GPS timing signal may provide a consistent reference clock to which multiple devices may be synchronized. In this regard, the source event controller 320 may include a GPS receiver capable of receiving GPS time references to facilitate synchronization between a local clock of the source event controller 320 and the reference clock. Furthermore, the acquisition system controller 310 and/or the individual acquisition modules 312 may include one or more GPS receivers also capable of receiving a GPS time reference signal for maintaining synchronization between the acquisition modules 310 and the reference clock. Any other known methods for synchronization of clocks to a reference clock may be employed in this regard. For example, one such approach to synchronization of module clocks in a seismic survey system is disclosed in U.S. Pat. No. 8,228757, which is incorporated by reference herein.

In an embodiment, it may be a case that only the source event controller 320 receives the source event schedule 400 for control of the seismic energy sources 322 with regard to the source event schedule 400. That is, the acquisition system controller 310 and/or acquisition modules 312 may operate without regard to the source event schedule 400. In this regard, the source events 410a-410n may be executed according to the source event schedule 400 and the acquisition modules 312 may collect corresponding seismic data without reference to the source event schedule 400. In this case, the source event schedule times 412a-412x may be also stored in a central database. In this regard, the seismic data may be received from acquisition modules 312 a form that does not include reference to the times at which the source events 410a-410n occurred. Accordingly, the seismic data acquired by the acquisition modules 312 may be later processed in relation to the source event schedule stored in the central database. In this embodiment, the acquisition modules 312 may still be synchronized to the reference clock, even though the source event schedule is not receive the acquisition modules 312. In this regard, seismic data acquired by the acquisition modules 312 may be timestamp or otherwise referenced to the reference clock such that the later correlation between the seismic data acquired by the acquisition modules 312 in the source event schedule 400 may be provided. In this regard, post survey processing of the data may still allow for correlation between the generation of source events 410a-410n and the seismic data acquired by the acquisition modules 312.

In another embodiment, the source event schedule 400 may be distributed to both the source event controller 32.0 as well as the acquisition system controller 310. In this regard, the acquisition modules 312 may be aware of the source event schedule 400 during the operation of the seismic survey. This embodiment may provide advantages in that the acquisition modules 312 may be controlled with reference to the source event schedule 400. For example, the acquisition modules 312 may be initiated and begin acquisition of data only during time periods associated with the source event scheduled times 412a-412x. For example, the acquisition modules 312 may initiate seismic data acquisition concurrently with the creation of the seismic source event 322 for each of the source event scheduled times 412a-412x. The acquisition modules 312 may initiate prior to the source event scheduled times 412a-412x in order to capture pre-event seismic data corresponding to conditions prior to the initiation a source event (e.g. to collect data that is indicative of noise levels or other environmental factors in the absence of the seismic energy created by the seismic energy source 322). As such, with the selective activation of the seismic acquisition modules 312 to coincide only with the generation of source events 410a-410n, the effective operating period for the acquisition modules 312 may be extended (e.g., in the case of a battery-operated module) or the power requirements associated with the acquisition modules 312 may be reduced because the acquisition modules 312 may be active only during the source events as determined per the source event schedule 400.

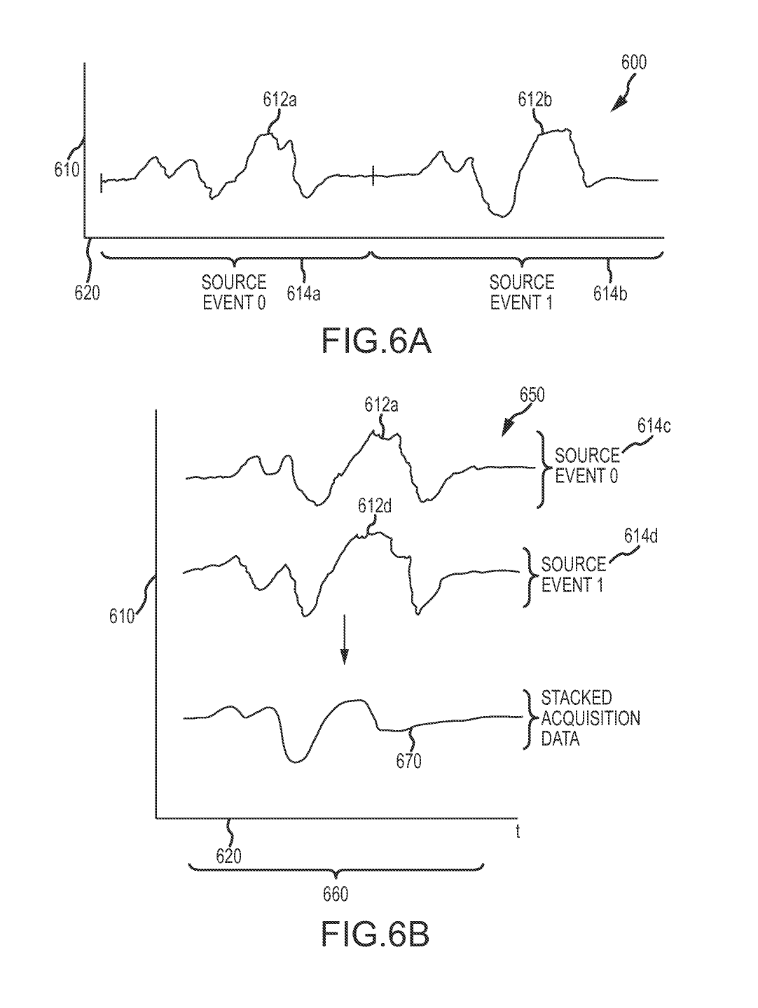

In an embodiment wherein the acquisition modules 312 receive the source event schedule 400 may also provide further advantages. For example, more advanced surveying techniques for data acquisition may be facilitated by way of the known source event schedule 400 at the acquisition module 312. In one example, data stacking may be performed at an acquisition module 312 during a seismic survey. With further reference to FIGS. 6A and 6B, data stacking refers to summing successive periods of seismic data from a plurality of source events 322 at a acquisition module 312 rather than serially collecting the data. In FIG. 6A, a data record 600 is shown representing seismic data on the vertical axis as recorded over a time represented on the horizontal axis 620. In FIG. 6A, the acquisition module 312 recording the seismic data may serially collect a first portion of seismic data 612a that reflects seismic energy associated with a first source event 614a during a first period of time. At a second period subsequent to the first period, the acquisition module 312 may collect seismic data 612b that reflects seismic energy associated with a second source event 614b during a second period of time. As may be appreciated in FIG. 6A, the first seismic data 612a and second seismic data 612b may be collected and represented in each respective period of time, which are serial and non-overlapping.

However, as shown in FIG. 6B, a data record 650 corresponding to a stacking procedure is shown. In FIG. 6B, the axes of the plot are the same as that in FIG. 6A. The acquisition module 312 may be operative to collect seismic data 612c and record the seismic data 612c in association with a period 660. The seismic data 612c corresponds to a first source event 614c. The acquisition module 312 may also collect seismic data 612d that corresponds to a second source event 614d. The seismic data 614d may be recorded in association with the same period 660 as seismic data 612c. In this regard, even if source events 614c and 614d occur in non-overlapping time periods, the seismic data 612c and 612d collected corresponding to the source events 614c and 614d may be recorded in association with a common period 660. In this regard, the seismic data 612c and 612d may be summed to produce a stacked data set 670. In this regard, the stacked data set 670 may include summed seismic data from one or more different source events that may occur in non-overlapping time periods. By summing the seismic data 612c and 612d, random noise may be cancelled such that a signal to noise ratio is improved in the stacked data set 670.

That is, the practice of data stacking may reduce noise in the seismic data acquired as noise present in each individual period of data acquisition associated with each individual seismic energy source 322 may be canceled upon the summation of the plurality of instances of the seismic energy source 320 (i.e., as noise is random, the random noise from each period acts to negate the effect of the noise on the summed signal). Data stacking has been heretofore unavailable in the context of acquisition systems without real time communication capabilities (e.g., blind read out systems) because the data stacking process generally involves communication with the seismic data acquisition modules to indicate that a plurality of successive energy sources 322 are associated with the stacking event rather than subsequent seismic energy sources 322 that should be recorded individually and serially. In this regard, it may be appreciated that even in blind read out systems the source event schedule 400 may be provided. In this regard, the source event schedule may also include stacking data 414 to indicate that one or more source events 410a-410n are part of a data stack such that the module 312, even the absence of communication with an acquisition system controller 310 or source event controller 320 may perform the data stacking operation as described above locally.

The source event schedule 400 may also include variations on the manner in which the scheduling of source events occurs. In this regard, it may be appreciated that the source event scheduled times 412a-412n may reference the reference clock absolutely or may include a relation to another occurrence (e.g., another source event). For example, in the example shown in FIG. 4, source events 410a and 410b include corresponding source event scheduled times that are defined with respect to an absolute reference clock value (e.g., times 10:00 and 10:30, respectively). However, source event 410c may include a relative source event scheduled time 412c that is defined relative to source event 410b (e.g. source event 410b plus 30 minutes). Accordingly, a source event schedule 400 may include absolute and/or relative source event scheduled times 412a-412x.

In the case of relative source event schedule times, exotic vibratory source effects may be facilitated such as, for example, slip sweep, ISS, or others, by adjusting the source events 322 according to geophysical specifications (e.g., distortion, depth of interest, etc.). In this regard, vibration controllers may be preprogrammed to deliver source events 320 in a predetermined series of source event scheduled times comprising a energy sweep. For instance, multiple fleets of vibration machinery may have source event scheduled times assigned according to cycle times and stacking periods. The vibration fleets could coordinate availability according to the number fleets and record cycle times.

It may be appreciated that the source event controller 320 may be a mobile unit that may move to various locations in the field to create source events 322. In this regard, the source events 322 may be at a predetermined location within the survey area. Additionally or alternatively, the source event controller 320 may be operable to determine the location of a source event prior to generation of the source event (e.g., by way of a GPS receiver at the source event controller 320). In any regard, the location of a source event 322 may be stored in a database for later reference in seismic data processing (e.g., relative to acquisition module 312 locations).

Furthermore, it may be that a source event 322 must be enabled or otherwise prepared prior to generation at a source event scheduled time 412. In this regard, it may be that one or more source events 322 may be missed as the source event 322 may not yet be enabled at the given source event reference time 412 for the source event. In this regard, the source event 322 may be rescheduled to correspond to another source event scheduled time 412. For example, a missed source event 322 may be automatically rescheduled for the next available time in which another source event 322 is not already scheduled.

In this regard, in the case of a mobile source event controller 320, a crew may be dispatched with the source event controller 320 that has the source event schedule 400 to enable source events 322 prior to the source event scheduled time 412 for each corresponding source event 322. As such, the crew may set out to enable each source events 322, wait for the source event scheduled time 412, allow for generation of the source event 322, then move on to the next source event 322, which again, may be predetermined with reference to the source event schedule 400. While the goal would be to complete all source events 322 as scheduled, it may be understood that, as described above, source events 322 may be missed. Metrics regarding the number of source events 322 generated versus the number of source events 322 scheduled may be recorded. In this regard, a survey operator may make resource decisions (E.g., regarding the number of source events 322 scheduled, the number of source event controller 320 employed, the number or type of crews dispatched, etc.) based on the calculated metrics.

Furthermore, in an embodiment, the source event controller 320 utilized in the seismic survey may be selectively controlled to function in either a traditional encoder/decoder control regime or a scheduled control regime as described herein. In this regard, the source event controller 320 may include a decoder capable of receiving control signals from an encoder for execution according to traditional to a radio communication techniques described above wherein a time break is delivered to the source event controller 320 (e.g., via two way radio communications) to initiate a source event 322. However, the same source controller 320 may also be selectively controlled to operate in a scheduled regime where the source event controller 320 may receive a source event schedule 400 and initiate seismic energy sources 322 with reference to the source event schedule 400. In this regard, a single source event controller 320 may be selectively programmed to employee a technique based on, for example, the specific parameters of a seismic survey in which the source of the controller 320 is employed.

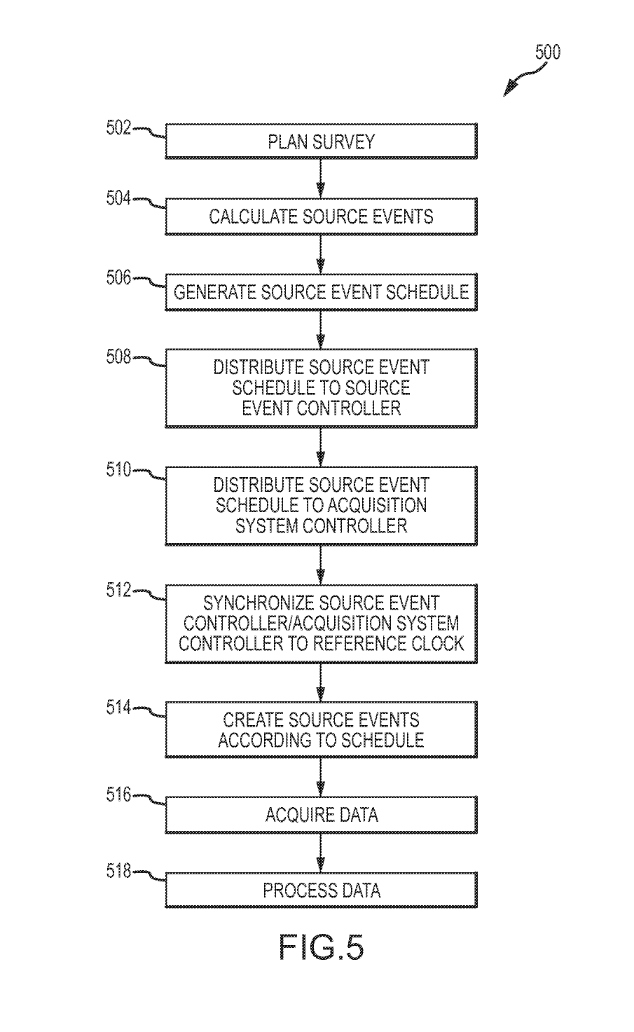

With further reference to FIG. 5, a flow chart depicting a process 500 for scheduled source event generation is shown. The process 500 may include planning 502 a seismic survey. In this regard, a number of survey parameters such as, for example, survey area size, acquisition module density, data parameters, source event parameters (e.g., including frequency, duration, amplitude, etc.), or other factors affecting the seismic survey may be considered in the planning 502. As indicated, the process 500 may include calculating 504 source event parameters for use in the seismic survey. In this regard, predefined source events may be calculated using, for example, record length, source type, acquisition parameters, or other factors affecting the timing, duration, length, or other factor of the source event.

In this regard, the process 500 may also include generating 506 a source event schedule. The generating 506 may take into account the calculated 504 source events for the seismic survey. The generating 506 may include establishing a source event scheduled time for each respective source event to be generated. As discussed above, the source event scheduled time may be an absolute reference to a reference clock time or a relative reference (e.g., to another source event).

The process 500 also includes distributing 508 the source event schedule resulting from the generating 506 to at least one source event controller. The distributing 508 may include, for example, physically providing a memory device at the source event controller that stores the source event schedule, connecting the source event controller to a memory device storing the source event schedule, or transmitting (e.g., via a wired or wireless connection) the source event schedule to the source event controller. Optionally, the process 500 also includes distributing 510 the source event schedule to an acquisition system as described above. In this regard, any of the foregoing modalities associated with distributing 508 the source event schedule to the source event controller may be equally applicable to distributing 510 the source event schedule to the acquisition system controller.

The process 500 may also include synchronizing 512 the source event controller and the acquisition system controller to the reference clock to which the source event schedule references. In this regard, the synchronizing 512 may include polling a GPS receiver to obtain a GPS clock reference signal used to synchronize a local clock or a module may accomplish the synchronizing 512 by simply employing the GPS clock reference signal for an internal clock. Other methods known for synchronizing a plurality of modules to a common reference clock may be utilized in the synchronizing 512.

The process 500 may also include creating 514 a source event as dictated at least in part by the source event schedule. As indicated above, the source event may be associated with any known source event in the art. The process 500 may include acquiring 516 seismic data associated with the created 514 source event at the acquisition system. Furthermore, the process 500 may include processing 518 the acquired data. In this regard, the processing 518 may include correlating the acquired seismic data to a known source event scheduled time to produce information regarding the survey area. Any known data processing technique may be employed that utilizes known source event creation times in reference to acquired data.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences. Accordingly, it should be understood that only the preferred embodiment and variants thereof have been shown and described and that all changes and modifications that come within the spirit of the invention are desired to be protected.

What is claimed is:

1. A method for generation of source events in seismic data acquisition, comprising:
scheduling a plurality of source events to define a source event schedule including a plurality of source event scheduled times, wherein the source event scheduled times are defined with respect to a reference clock;
providing the source event schedule to at least one seismic source, wherein the seismic source is synchronized corresponding to the reference clock;
initiating a source event for at least one source event scheduled time as determined with reference to the reference clock at the seismic source.

2. A method according to claim 1, wherein the initiating of the source event occurs independently of control communications between a source event encoder and a source event decoder.

3. A method according to claim 2, wherein the reference clock comprises a GPS time reference signal.

4. A method according to claim 1, wherein the source event schedule including the source event scheduled times is stored in a central database.

5. A method according to claim 4, further comprising acquiring seismic data corresponding to the source event with at least one seismic data acquisition module with reference to the reference clock.

6. A method according to claim 5, further comprising appending timestamp data regarding the reference clock to the seismic data.

7. A method according to claim 6, wherein the seismic data is correlated to the source vent schedule during post survey processing of the seismic data.

8. A method according to claim 6, further comprising synchronizing the seismic data acquisition module with regard to the reference clock.

9. A method according to claim 7, further comprising distributing the source event schedule to the seismic data acquisition module.

10. A method according to claim 8, wherein the seismic data acquisition module only acquires seismic data in a time corresponding to a source event scheduled time.

11. A method according to claim 8, wherein the source event schedule designates at least two of the plurality of source event scheduled times as corresponding to an acquisition stacking event, wherein the method includes combining, at the seismic data acquisition module, seismic data from each source event scheduled times.

12. A method according to claim 11, wherein the source event schedule includes instructions regarding the acquisition stacking event for controlling the operation of the seismic data acquisition module.

13. A method according to claim 1, wherein at least one of the plurality of source event scheduled times corresponds to an absolute time of the reference clock.

14. A method according to claim 1, wherein at least one of the plurality of source event scheduled times corresponds to a relative time.

15. A method according to claim 14, wherein the relative time references another source event scheduled time.

16. A method according to claim 15, wherein the providing includes sending the source event schedule from a remote location to the source event controller.

17. A method according to claim 16, wherein the providing includes wirelessly transmitting the source event schedule to the source event controller.

18. A method according to claim 1, wherein the source event schedule corresponds to a predetermined time period.

19. A system for seismic data acquisition, comprising:
a source event scheduler for generating of as source event schedule including at least one source event scheduled time, wherein the at least one source event scheduled time is defined relative to a reference clock, and
a source event controller in operative communication with the source event scheduler to receive the source event schedule, wherein source event controller is operable to generate a source event at the at least one source event scheduled time; and
wherein the source event generated by the source event controller is generated based on a clock at the source event controller synchronized to the reference clock and is independent of source encoder and source decoder communications.

20. A system according to claim 19, wherein the source event controller further comprises an encoder operable to receive a control signal from a decoder to initiate as source event, wherein the source event controller is selectively operable to generate a source event based on the control signal received from the decoder or based on the source event schedule with reference to the reference clock.
